(19) United States
(12) Patent Application Publication
(10) Pub. No.: US 2025/0279514 A1
(43) Pub. Date: Sep. 4, 2025

(54) BATTERY AND BATTERY MODULE

(71) Applicant: KABUSHIKI KAISHA TOSHIBA, Tokyo (JP)

(72) Inventor: Kenji WATANABE, Yokohama Kanagawa (JP)

(73) Assignee: KABUSHIKI KAISHA TOSHIBA, Tokyo (JP)

(21) Appl. No.: 19/212,788

(22) Filed: May 20, 2025

Related U.S. Application Data
(63) Continuation of application No. PCT/JP2023/010108, filed on Mar. 15, 2023.

(51) Int. Cl. H01M 50/176; H01M 50/103; H01M 50/15; H01M 50/503; H01M 50/553

(52) U.S. Cl. CPC H01M 50/176; H01M 50/103; H01M 50/15; H01M 50/503; H01M 50/553

(57) ABSTRACT

In an embodiment, a battery includes an exterior part, an electrode group, a terminal, and an insulator, and the electrode group is housed in an internal cavity of the exterior part. The terminal is inserted into the internal cavity through the exterior part and includes a terminal head arranged outside the exterior part. The insulator includes a bottom portion sandwiched between the terminal head and an outer surface of the exterior part, and a covering portion covering the terminal head from an outer peripheral side of the terminal on the outer surface of the exterior part. The covering portion abuts on the outer surface of the exterior part, and a protruding height of the covering portion from the outer surface of the exterior part is a protruding height of the terminal head from the outer surface of the exterior part or more over an entire circumference.

### CROSS-REFERENCE TO RELATED APPLICATIONS

This is a Continuation application of PCT Application No. PCT/JP2023/010108, filed Mar. 15, 2023, the entire contents of which are incorporated herein by reference.

### FIELD

Embodiments relate to a battery and a battery module.

### BACKGROUND

As a battery such as a lithium ion secondary battery, there is a battery in which an electrode group is housed in an internal cavity of an exterior part. In such a battery, a terminal (electrode terminal) is attached to the exterior part, and the terminal is electrically connected to the electrode group via a lead or the like. In the battery, an electrical path from the electrode group is formed through the lead and the terminal. As terminals used in batteries, a terminal including a terminal head is available. In the battery in which the terminal with a terminal head is used, the terminal is inserted through the exterior part into the internal cavity, and the terminal head is arranged outside the exterior part.

In the case where a battery module in which a plurality of batteries are electrically connected is assembled using the above-described batteries, bus bars are connected to terminals of the batteries, and the plurality of batteries are electrically connected via the bus bars. In a work of assembling the battery module, to confirm the dimensions of the battery module to be assembled, measurement and the like of the dimensions of the batteries forming the battery module are performed. In work such as assembling a battery module using a battery in which a terminal head of a terminal is arranged outside an exterior part, it is required to appropriately prevent unintended contact of the terminal head arranged outside the exterior part with a conductor so as to appropriately prevent occurrence of a short circuit caused by contact of the terminal head with the conductor.

### BRIEF DESCRIPTION OF THE DRAWINGS

FIG. 1 is a perspective view showing a battery according to a first embodiment.

FIG. 2 is a schematic view showing the battery according to the first embodiment as viewed from one side in a depth direction.

FIG. 3 is a plan view showing the battery according to the first embodiment as viewed from one side in a height direction.

FIG. 4 is a cross-sectional view showing the battery according to the first embodiment, taken along a cross-section orthogonal or substantially orthogonal to a lateral direction.

FIG. 5 is a cross-sectional view showing a configuration of one of a pair of terminals and a vicinity thereof in the battery according to the first embodiment, which is taken along a cross section orthogonal or substantially orthogonal to the lateral direction of the battery.

FIG. 6 is a perspective view showing a battery module according to the first embodiment.

FIG. 7 is a cross-sectional view explaining a configuration in which bus bars are connected to terminals of batteries in the battery module according to the first embodiment.

FIG. 8 is a perspective view showing a battery module according to a first modification.

FIG. 9 is a perspective view showing a battery module according to a second modification.

### DETAILED DESCRIPTION

According to an embodiment, a battery includes an exterior part, an electrode group, a terminal, and an insulator, and the exterior part has an internal cavity. The electrode group includes a positive electrode and a negative electrode and is housed in the internal cavity. The terminal is inserted into the internal cavity through the exterior part and is electrically connected to the electrode group. The terminal includes a terminal head arranged outside the exterior part. The insulator includes a bottom portion sandwiched between the terminal head and the outer surface of the exterior part, and a covering portion covering the terminal head from an outer peripheral side of the terminal on the outer surface of the exterior part, and has electrical insulation properties. The covering portion abuts on the outer surface of the exterior part, and the protruding height of the covering portion from the outer surface of the exterior part is the protruding height of the terminal head from the outer surface of the exterior part or more over the entire circumference.

Hereinafter, embodiments will be described with reference to the drawings.

### First Embodiment

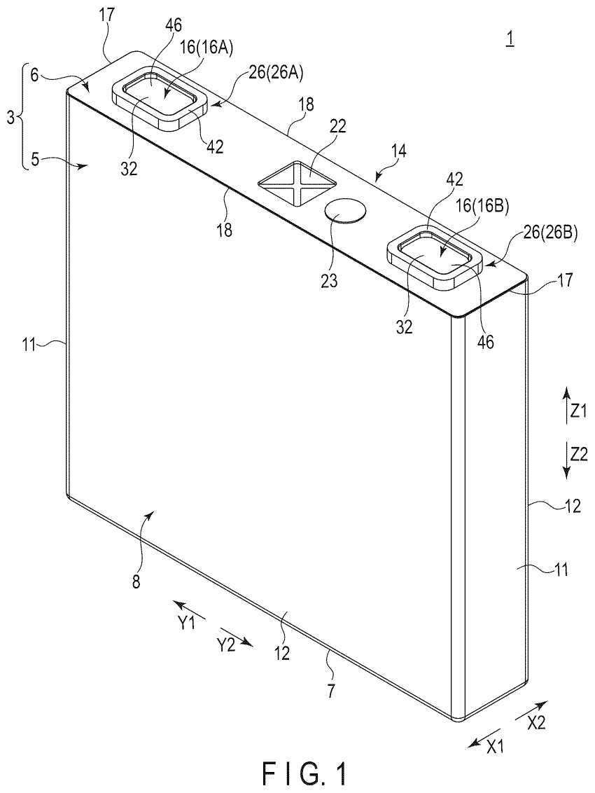

Hereinafter, a first embodiment will be described as an example of the embodiment. First, a single battery 1, which is an unit cell used in the first embodiment, will be described. FIGS. 1, 2, 3, and 4 illustrate the battery 1 according to the first embodiment. As shown in FIGS. 1 to 4, the battery 1 includes an electrode group 2 and an exterior part 3. In the example in FIGS. 1 to 4, the exterior part 3 includes an exterior container 5 and a lid member 6. The exterior part 3 including the exterior container 5 and the lid member 6 is formed of a metal such as aluminum, an aluminum alloy, iron, copper, or stainless steel, and has conductivity.

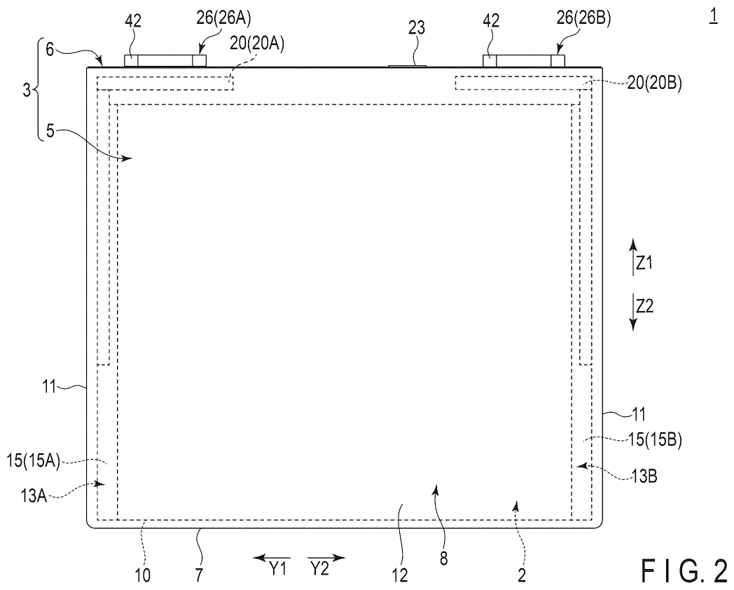

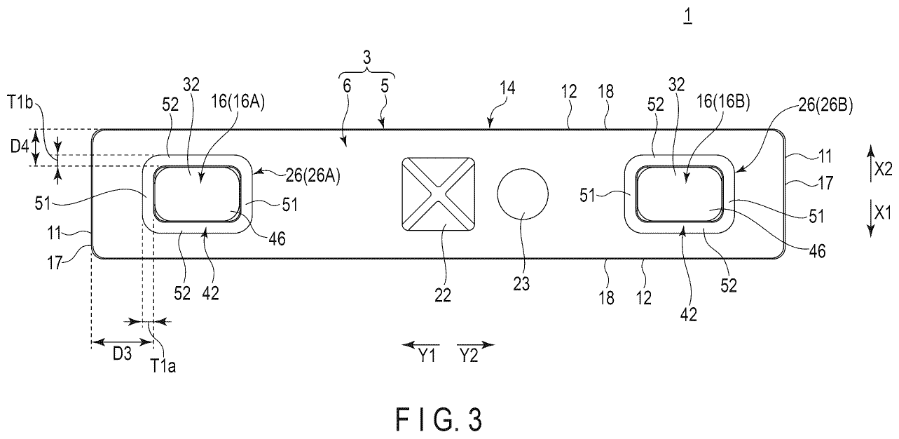

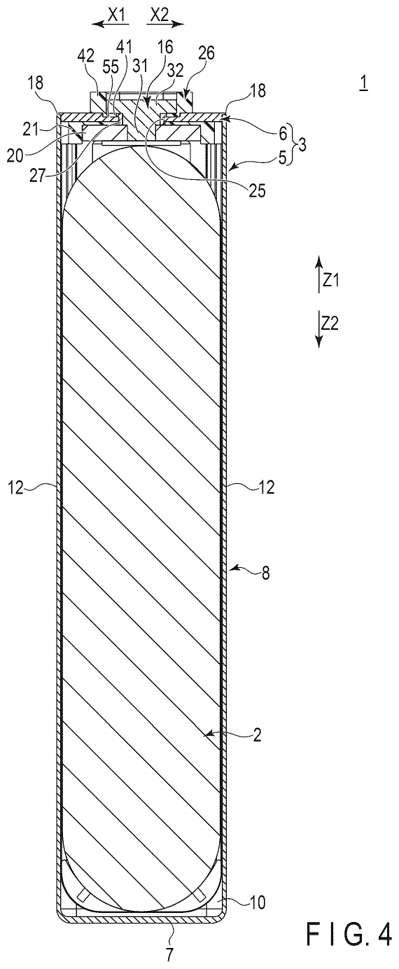

In the example of the battery 1 (exterior part 3) in FIGS. 1 to 4, a depth direction (a direction indicated by arrows X1 and X2), a lateral direction (a direction indicated by arrows Y1 and Y2) intersecting (orthogonal or substantially orthogonal to) the depth direction, and a height direction (a direction indicated by arrows Z1 and Z2) intersecting (orthogonal or substantially orthogonal to) both the depth direction and the lateral direction are defined. In each of the battery 1 and the exterior part 3, the dimension in the depth direction is smaller than each of the dimension in the lateral direction and the dimension in the height direction. FIG. 1 is a perspective view, and FIG. 2 is a view as viewed from one side in the depth direction. FIG. 3 is a view as viewed from one side in the height direction, and FIG. 4 shows a cross section orthogonal or substantially orthogonal to the lateral direction.

The exterior container 5 includes a bottom wall 7 and a peripheral wall 8. An internal cavity 10 is formed inside the exterior part 3, and the internal cavity 10 is defined by the bottom wall 7 and the peripheral wall 8 of the exterior container 5. In the exterior container 5, the internal cavity 10 is open toward the side opposite to the side where the bottom wall 7 is located in the height direction. The peripheral wall 8 includes two pairs of side walls 11 and 12. The pair of side walls 11 are opposed to each other in the lateral direction with the internal cavity 10 therebetween. The pair of side walls 12 are opposed to each other in the depth direction with the internal cavity 10 therebetween. Each of the side walls 11 is continuously extended along the depth direction between the side walls 12. Each of the side walls 12 extends continuously along the lateral direction between the side walls 11. The lid member 6 is attached to the peripheral wall 8 to an end portion in the opposite side to the bottom wall 7. Thus, the lid member 6 closes the opening of the internal cavity 10. The lid member 6 and the bottom wall 7 are opposed to each other in the height direction with the internal cavity 10 therebetween. The lid member 6 is attached to the peripheral wall 8 by welding such as seam welding.

In the example in FIGS. 1 to 4, the lid member 6 is attached to the peripheral wall 8 of the exterior container 5 in a state where the thickness direction of the lid member 6 coincides or substantially coincides with the height direction of the battery 1. The lid member 6 includes a peripheral edge 14 forming an edge of the outer surface. In the battery 1, the peripheral edge 14 is welded to the peripheral wall 8 of the exterior container 5. The peripheral edge 14 includes a pair of short edges 17 and a pair of long edges 18. The pair of short edges 17 are positioned apart from each other in the lateral direction of the battery 1, and each of the short edges 17 is continuously extended along the depth direction of the battery 1 between the pair of long edges 18. The pair of long edges 18 are positioned apart from each other in the depth direction of the battery 1, and each of the long edges 18 is continuously extended along the lateral direction of the battery 1 between the pair of short edges 17. In the battery 1, each of the short edges 17 is welded to a corresponding one of the pair of side walls 11, and each of the long edges 18 is welded to a corresponding one of the pair of side walls 12. The dimension of the lid member 6 in the depth direction of the battery 1 (a direction along the short edge 17) is smaller than the dimension of the lid member 6 in the lateral direction of the battery 1 (a direction along the long edge 18).

The electrode group 2 is housed in the internal cavity 10. In FIG. 2, some of the components housed in the internal cavity 10, such as the electrode group 2, are illustrated by broken lines. The electrode group 2 includes a positive electrode 13A and a negative electrode 13B. In the electrode group 2, a separator (not shown) is interposed between the positive electrode 13A and the negative electrode 13B. The separator has electrical insulation properties and electrically insulates the positive electrode 13A from the negative electrode 13B.

The positive electrode 13A includes a positive electrode current collector such as a positive electrode current collector foil and a positive electrode active material-containing layer (not shown) supported on a surface of the positive electrode current collector. The positive electrode current collector is, but is not limited to, for example, an aluminum foil or an aluminum alloy foil, and has a thickness of approximately 10 μm to 20 μm. The positive electrode active material-containing layer includes a positive electrode active material, and may optionally include a binder and an electro-conductive agent. Examples of the positive electrode active material include, but are not limited to, oxides, sulfides, polymers, and the like capable of occluding and releasing lithium ions. The positive electrode current collector includes a positive electrode current collecting tab 15A as a portion not supporting the positive electrode active material-containing layer.

The negative electrode 13B includes a negative electrode current collector such as a negative electrode current collector foil, and a negative electrode active material-containing layer (not shown) supported on a surface of the negative electrode current collector. The negative electrode current collector is, but is not limited to, for example, an aluminum foil, an aluminum alloy foil, or a copper foil, and has a thickness of approximately 10 μm to 20 μm. The negative electrode active material-containing layer includes a negative electrode active material, and may optionally include a binder and an electro-conductive agent. The negative electrode active material is not particularly limited, and examples thereof include metal oxides, metal sulfides, metal nitrides, and carbon materials capable of occluding and releasing lithium ions. The negative electrode current collector includes a negative electrode current collecting tab 15B as a portion not supporting the negative electrode active material-containing layer.

In the example of the electrode group 2 shown in FIGS. 2 and 3, the positive electrode 13A, the negative electrode 13B, and the separator are wound in a state where the separator is sandwiched between the negative electrode active material-containing layer and the positive electrode active material-containing layer, thus forming the electrode group 2 having a wound structure. In another example, the electrode group 2 has a stack structure in which a plurality of positive electrode plates serving as a positive electrode 13A and a plurality of negative electrode plates serving as a negative electrode 13B are alternately stacked, and a separator is provided between the positive electrode plate and the negative electrode plate. As a result of forming the electrode group 2 as described above, in the electrode group 2, the positive electrode current collecting tab 15A and the negative electrode current collecting tab 15B are formed as a pair of current collecting tabs 15. The pair of current collecting tabs 15 do not contact each other and are electrically insulated from each other.

In the electrode group 2, each of the pair of current collecting tabs 15 protrudes with respect to the positive electrode active material-containing layer, the negative electrode active material-containing layer, the separator, and the like. In the example in FIGS. 2 and 3, the pair of current collecting tabs 15 protrude to opposite sides to each other. The electrode group 2 is arranged in the internal cavity 10 in a state where the positive electrode current collecting tab 15A protrudes to one side in the lateral direction of the battery 1 and the negative electrode current collecting tab 15B protrudes to the side opposite to the side where the positive electrode current collecting tab 15A protrudes in the lateral direction of the battery 1. In an example of the electrode group 2, the pair of current collecting tabs 15 protrude toward the same side. In this case, the electrode group 2 is arranged in the internal cavity 10 in a state where the pair of current collecting tabs 15 (the positive electrode current collecting tab 15A and the negative electrode current collecting tab 15B) protrude toward the side where the lid member 6 is located in the height direction of the battery 1. The pair of current collecting tabs 15 are arranged apart from each other in the lateral direction of the battery 1.

In the internal cavity 10, the electrode group 2 holds (is impregnated with) an electrolytic solution (not shown). The electrolytic solution may be a nonaqueous electrolytic solution in which an electrolyte is dissolved in an organic solvent, or may be an aqueous electrolytic solution such as an aqueous solution. Instead of the electrolytic solution, a gel electrolyte may be used, or a solid electrolyte may be used. In the case where the solid electrolyte is used as the electrolyte, the solid electrolyte is interposed between the positive electrode 13A and the negative electrode 13B instead of the separator in the electrode group. In this case, the positive electrode 13A is electrically insulated from the negative electrode 13B by the solid electrolyte.

In the battery 1, a pair of terminals 16 are attached to the lid member 6 of the exterior part 3. The terminal 16 is formed of a conductive material such as metal. One of the pair of terminals 16 is a positive electrode terminal 16A of the battery 1, and the other of the pair of terminals 16 which is different from the positive electrode terminal 16A is a negative electrode terminal 16B of the battery 1. Each of the terminals 16 is attached to the lid member 6 in a state where a part of the terminal 16 is located outside the exterior part 3. Each of the terminals 16 penetrates the lid member 6 along the height direction of the battery 1, and is inserted into the internal cavity 10 penetrating through the lid member 6. The pair of terminals 16 are arranged apart from each other in the lateral direction of the battery 1. In FIG. 4, a cross section through one of the pair of terminals 16 is shown.

A pair of leads 20 are arranged in the internal cavity 10 of the exterior part 3. In FIG. 2, the pair of leads 20 are shown by a broken line together with the electrode group 2. One of the pair of leads 20 is a positive electrode side lead 20A, and the other of the pair of leads 20 which is different from the positive electrode side lead 20A is a negative electrode side lead 20B. Each of the leads 20 is formed of a conductive material such as metal. Examples of the conductive material forming the lead 20 include aluminum, stainless steel, copper, and iron. The positive electrode side lead 20A forms at least a part of an electrical path between the positive electrode current collecting tab 15A and the positive electrode terminal 16A, and connects the positive electrode 13A of the electrode group 2 and the positive electrode terminal 16A. Thus, the positive electrode terminal 16A is electrically connected to the positive electrode 13A of the electrode group 2. The negative electrode side lead 20B forms at least a part of an electrical path between the negative electrode current collecting tab 15B and the negative electrode terminal 16B, and connects the negative electrode 13B of the electrode group 2 and the negative electrode terminal 16B. Thus, the negative electrode terminal 16B is electrically connected to the negative electrode 13B of the electrode group 2.

As described above, in the battery 1, each of the pair of current collecting tabs 15 is connected to a corresponding one of the pair of terminals 16 via a corresponding one of the pair of leads 20. The shape of each lead 20 is not limited to the shapes shown in figures such as FIGS. 2 and 4. In the example in FIGS. 2 and 4, each of the leads 20 includes two leg portions, but in an example, each of the leads 20 may include only one leg portion. In the configuration in which the pair of current collecting tabs 15 (the positive electrode current collecting tab 15A and the negative electrode current collecting tab 15B) in the electrode group 2 protrude toward the side where the lid member 6 is located in the height direction, the shape of each lead 20, the arrangement of each lead 20 in the internal cavity 10, and the like are different from those in the configuration of the example shown in FIGS. 2 and 4. However, even in the configuration in which the pair of current collecting tabs 15 protrude toward the side where the lid member 6 is located in the height direction, each of the pair of current collecting tabs 15 is connected to a corresponding one of the pair of terminals 16 via a corresponding one of the pair of leads 20.

As shown in FIG. 4, etc., in the internal cavity 10, an electrode group holder 21 serving as an internal insulator is arranged between the electrode group 2 and the lid member 6 in the height direction of the battery 1. The electrode group holder 21 is arranged between each of the leads 20 and the lid member 6 in the height direction of the battery 1. The electrode group holder 21 has electrical insulation properties. The pair of current collecting tabs 15 and the pair of leads 20 are prevented from contacting the lid member 6 by the electrode group holder 21, and are electrically insulated from the lid member 6. In the internal cavity 10, each of the terminals 16 penetrates the electrode group holder 21 along the height direction of the battery 1, and is connected to a corresponding one of the leads 20 in a state of penetrating the electrode group holder 21.

A pair of insulating guards (not shown) are arranged as internal insulators in the internal cavity 10 of the exterior part 3. Each of the insulating guards has electrical insulation properties. Each of the pair of insulating guards prevents the corresponding one of the pair of current collecting tabs 15 and the corresponding one of the pair of leads 20 from contacting the exterior container 5. Thus, the pair of current collecting tabs 15 and the pair of leads 20 are electrically insulated from the exterior container 5. Therefore, the electrode group holder 21 and the insulating guard serving as the internal insulator electrically insulate the pair of current collecting tabs 15 and the pair of leads 20 from the exterior part 3 including the exterior container 5 and the lid member 6.

In the battery 1 of the example shown in FIGS. 1 to 4, a gas release valve 22 and a liquid injection port (not shown) are formed in the lid member 6. A sealing plate 23 to close the liquid injection port is welded to the outer surface of the lid member 6. The gas release valve 22 and the liquid injection port are arranged between the pair of terminals 16 in the lateral direction of the battery 1. In the battery 1, the gas release valve 22, the liquid injection port, and the like may not be provided.

In the battery 1, the lid member 6 of the exterior part 3 is provided with a pair of through holes 25. In the lid member 6, the pair of through holes 25 are formed apart from each other in the lateral direction of the battery 1, and only one of the pair of through holes 25 is shown in FIG. 4. Each of the through holes 25 extends through the lid member 6 along the height direction of the battery 1 from the outer surface of the lid member 6 (the outer surface of the exterior part 3) to the internal cavity 10. Each of the pair of terminals 16 penetrates the lid member 6 in a corresponding one of the pair of through holes 25, and is inserted into the internal cavity 10 from the corresponding one of the through holes 25. Then, each of the pair of terminals 16 is attached to the lid member 6 to the corresponding one of the pair of through holes 25 and the vicinity thereof. One of the pair of through holes 25 into which the positive electrode terminal 16A is inserted is a positive electrode side through hole, and one of the pair of through holes 25 into which the negative electrode terminal 16B is inserted is a negative electrode side through hole.

The battery 1 includes a pair of insulators 26 and a pair of gaskets 27. Each of the insulator 26 and the gasket 27 are provided corresponding to the positive electrode terminal 16A and each of the insulator 26 and the gasket 27 are provided corresponding to the negative electrode terminal 16B. One of the pair of insulators (terminal insulators) 26 corresponding to the positive electrode terminal 16A is a positive electrode side insulator 26A, and one of the pair of insulators 26 corresponding to the negative electrode terminal 16B is a negative electrode side insulator 26B. One of the pair of gaskets 27 corresponding to the positive electrode terminal 16A is a positive electrode side gasket, and one of the pair of gaskets 27 corresponding to the negative electrode terminal 16B is a negative electrode side gasket. In FIG. 4, only one of the pair of insulators 26 is shown, and only one of the pair of gaskets 27 is shown.

Each of the insulators (terminal insulators) 26 has electrical insulation properties, and is formed of, for example, a resin having electrical insulation properties. Each of the gaskets 27 has electrical insulation properties, and is formed of, for example, a resin having electrical insulation properties. Each of the gaskets 27 is formed in, for example, a ring shape or a substantially ring shape. In the present embodiment, each of the terminals 16 is prevented from contacting the lid member 6 by the corresponding one of the insulators 26 and the corresponding one of the gaskets 27 in the mounting portion to the lid member 6 of the exterior part 3, and is electrically insulated from the exterior part 3 including the lid member 6.

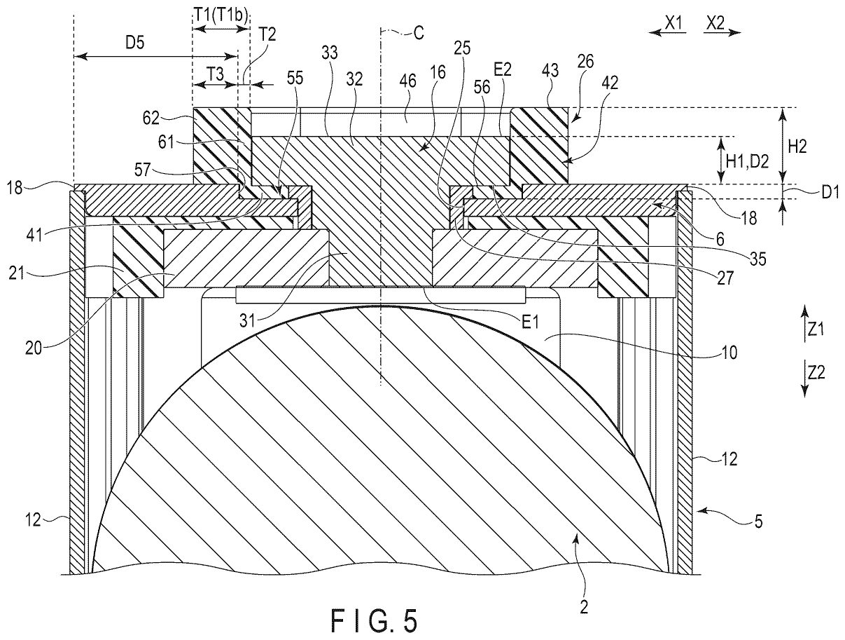

Hereinafter, the configuration of one of the pair of terminals 16 and the configuration of the mounting portion of the terminal 16 to the exterior part 3 (lid member 6) will be described. FIG. 5 shows a configuration of one of the pair of terminals 16 and the vicinity thereof. FIG. 5 shows one of the pair of terminals 16 and the vicinity thereof in the same cross section as FIG. 4. Thus, FIG. 5 shows a cross section perpendicular or substantially perpendicular to the lateral direction of the battery 1 and passing through the terminal 16. The other of the pair of terminals 16 and the mounting portion of the terminal 16 to the exterior part 3 (lid member 6) have the same configuration as described below. That is, the other of the pair of terminals 16 and the insulator 26 and the gasket 27 corresponding to the terminal 16 have the same configuration as that shown in FIG. 5 and the like, and have the same configuration as that described below.

As shown in FIG. 5 and the like, the terminal 16 has a central axis C. In the terminal 16 and the mounting portion of the terminal 16, a direction along the central axis C is defined as an axial direction, and a direction around the central axis C is defined as a circumferential direction. In the terminal 16 and the mounting portion of the terminal 16, a direction orthogonal or substantially orthogonal to the central axis C is defined as a radial direction. In the terminal 16 and the mounting portion of the terminal 16, a side away from the central axis C in the radial direction is an outer peripheral side, and a side toward the central axis C in the radial direction is an inner peripheral side.

The terminal 16 includes a terminal shaft 31 and a terminal head 32. The terminal head 32 is provided adjacent to one side of the terminal shaft 31 in the axial direction of the terminal 16, and the terminal head 32 protrudes to the outer peripheral side with respect to the terminal shaft 31. The terminal head 32 protrudes from the terminal shaft 31 to the outer peripheral side over the entire circumference of the terminal 16 in the circumferential direction (direction around the central axis C). Therefore, in the terminal 16, the cross-sectional area of the terminal head 32 in a cross section orthogonal or substantially orthogonal to the central axis C is greater than the cross-sectional area of the terminal shaft 31 in a cross section orthogonal or substantially orthogonal to the central axis C. In the terminal 16, an end E1 on one side in the axial direction is formed by the shaft 31, and an end E2 on the opposite side to the end E1 in the axial direction is formed by the terminal head 32. The terminal 16 is attached to the lid member 6 in a state where the central axis C is along the height direction of the battery 1, that is, in a state where the axial direction coincides or substantially coincides with the height direction of the battery 1.

In the terminal 16, the terminal shaft 31 is inserted into the internal cavity 10 from the through hole 25 of the lid member 6. That is, the terminal shaft 31 of the positive electrode terminal 16A is inserted into the internal cavity 10 from the positive electrode side through hole, and the terminal shaft 31 of the negative electrode terminal 16B is inserted into the internal cavity 10 from the negative electrode side through hole. In the internal cavity 10, the terminal shaft 31 of the terminal 16 penetrates the electrode group holder 21. In the internal cavity 10, the terminal shaft 31 of the terminal 16 is connected to the leads 20 (corresponding one of the positive electrode side lead 20A and the negative electrode side lead 20B) between the electrode group 2 and the electrode group holder 21 in the height direction of the battery 1.

The terminal head 32 of the terminal 16 is arranged outside the exterior part 3. In the example in FIGS. 1 to 5, the terminal head 32 is arranged outside the exterior part 3 in a state of protruding from the outer surface of the lid member 6. As shown in FIG. 5 and the like, the terminal head 32 of the terminal 16 includes head end faces 33 and 35. In the terminal 16, the end E2 is formed by the head end face (first head end face) 33 which is a head upper end face, and in the terminal head 32, the end on a side far from the terminal shaft 31 in the axial direction is formed by the head end face 33. In the terminal head 32 of the terminal 16, an end on the side close to the terminal shaft 31 in the axial direction is formed by the head end face (second head end face) 35 which is a head lower end face, and the head end face 35 is located in a boundary portion with the terminal shaft 31.

In the terminal 16, as described above, the terminal head 32 protrudes to the outer peripheral side with respect to the terminal shaft 31. Therefore, in the terminal 16, a step is formed in the boundary portion between the terminal head 32 and the terminal shaft 31 by the head end face 35. In the terminal 16, the outer peripheral surface of the terminal head 32 is located toward the outer peripheral side with respect to the outer peripheral surface of the terminal shaft 31 due to the step in the boundary portion between the terminal shaft 31 and the terminal head 32. In the terminal head 32, the outer peripheral surface of the terminal head 32 is continuously extended between the head end faces 33 and 35 along the axial direction of the terminal 16, and is extended over the entire circumference in the circumferential direction of the terminal 16.

In the terminal head 32 of the terminal 16, the end on the side far from the outer surface of the lid member 6 (the outer surface of the exterior part 3) is formed by the head end face (first head end face) 33, and the end on the side close to the outer surface of the lid member 6 is formed by the head end face (second head end face) 35. In the terminal head 32, the head end face 33 faces the side opposite to the side where the outer surface of the lid member 6 is located, and the head end face 35 opposes the outer surface of the lid member 6. The terminal head 32 is arranged in a state where the terminal head 32 does not abut on the exterior part 3 (lid member 6) and a gap is provided between the head end face 35 and the outer surface of the lid member 6. Thus, a separation distance D1 between the outer surface of the lid member 6 and the terminal head 32 is defined in the terminal 16.

In the terminal head 32 of the terminal 16, the head end face 33 forms a protruding end of the protruding portion from the outer surface of the lid member 6, and the head end face 33 serves as a protruding end face of the protruding portion from the outer surface of the lid member 6. In the terminal 16, the protruding height H1 is defined as the dimension between the base position of the protruding portion of the terminal head 32 and the protruding end of the terminal head 32. In the terminal 16, the protruding height H1 corresponds to the distance from the outer surface of the lid member 6 to the head end face 33, which is a protruding end face, along the axial direction (the height direction of the battery 1). In the terminal 16, a distance D2 corresponding to a distance between the head end faces 33 and 35 of the terminal head 32 along the axial direction is also defined.

In the example shown in FIGS. 1 to 5, in the terminal 16, a distance D3 from the outer peripheral surface of the terminal head 32 to the closer one of the pair of short edges 17 of the lid member 6 along the lateral direction of the battery 1 is also defined. In the terminal 16, a distance D4 from the outer peripheral surface of the terminal head 32 to the pair of long edges 18 of the lid member 6 along the depth direction of the battery 1 is defined. The distance D4 is smaller than the distance D3.

The gasket 27 covers the terminal shaft 31 of the terminal 16 from the outer peripheral side in the through hole 25 (corresponding one of the positive electrode side through hole and the negative electrode side through hole). The gasket 27 covers the terminal shaft 31 from the outer peripheral side over the entire circumference in the circumferential direction of the terminal 16. The gasket 27 is sandwiched between the terminal shaft 31 of the terminal 16 and the peripheral edge of the through hole 25. That is, the positive electrode side gasket is sandwiched between the terminal shaft 31 of the positive electrode terminal 16A and the peripheral edge of the positive electrode side through hole, and the negative electrode side gasket is sandwiched between the terminal shaft 31 of the negative electrode terminal 16B and the peripheral edge of the negative electrode side through hole.

With the above-described configuration, the gasket 27 prevents the terminal 16 from coming into contact with the peripheral edge of the through hole 25. The gasket 27 maintains the space between the peripheral edge of the through hole 25 and the terminal shaft 31 of the terminal 16 in an air-tight and liquid-tight manner. Therefore, in the portion where the terminal 16 is mounted to the exterior part 3, the gasket 27 prevents the electrolyte, gas, and the like from leaking from the internal cavity 10 to the outside of the exterior part 3 through the through hole 25.

As shown in FIG. 5 and the like, the insulator 26 includes a bottom portion 41 serving as a bottom wall and a covering portion 42 serving as a peripheral wall. In the mounting portion of the terminal 16 to the lid member 6, the insulator 26 is arranged on the outer surface of the lid member 6 (the outer surface of the exterior part 3). In the insulator 26, the bottom portion 41 and the covering portion 42 abut on the outer surface of the lid member 6. The bottom portion 41 of the insulator 26 is adjacent to the gasket 27 from the outer peripheral side in the mounting portion of the terminal 16, and covers the gasket 27 from the outer peripheral side over the entire circumference. The bottom portion 41 of the insulator 26 is arranged in a gap between the terminal head 32 (head end face 35) of the terminal 16 and the outer surface of the lid member 6, and is sandwiched between the terminal head 32 of the terminal 16 and the outer surface of the lid member 6. The terminal 16 penetrates the bottom portion 41 of the insulator 26 and is inserted into the internal cavity 10.

In the insulator 26, the outer peripheral end of the bottom portion 41 is connected to the covering portion 42, and the bottom portion 41 protrudes from the covering portion 42 to the inner peripheral side over the entire circumference. Therefore, in the mounting portion of the terminal 16 to the lid member 6, the covering portion 42, the bottom portion 41, the gasket 27, and the terminal shaft 31 are arranged in this order from the outer peripheral side. In the insulator 26, the covering portion 42 is extended from a position connected to the bottom portion 41 along the axial direction (central axis C) of the terminal 16. The insulator 26 is arranged in a state where the covering portion 42 protrudes from the outer surface of the lid member 6.

The covering portion 42 of the insulator 26 covers the terminal head 32 of the terminal 16 from the outer peripheral side on the outer surface of the lid member 6. That is, the positive electrode side insulator 26A covers the terminal head 32 of the positive electrode terminal 16A from the outer peripheral side, and the negative electrode side insulator 26B covers the terminal head 32 of the negative electrode terminal 16B from the outer peripheral side. The insulator 26 covers the terminal head 32 of the terminal 16 from the outer peripheral side over the entire circumference in the circumferential direction. Therefore, in the mounting portion of the terminal 16 to the lid member 6, the covering portion 42 and the terminal head 32 are arranged in this order from the outer peripheral side. In the mounting portion of the terminal 16, the inner peripheral surface of the covering portion 42 of the insulator 26 abuts on the outer peripheral surface of the terminal head 32.

The covering portion 42 of the insulator 26 includes an extending end face 43. In the covering portion 42, an end on the side opposite to the side connected to the bottom portion 41 is formed by the extending end face 43. The covering portion 42 of the insulator 26 is extended along the axial direction of the terminal 16 from the position connected to the bottom portion 41 to the extending end face 43. In the covering portion 42 of the insulator 26, the end on the side far from the outer surface of the lid member 6 (the outer surface of the exterior part 3) is formed by the extending end face 43. In the covering portion 42, the extending end face 43 faces the side opposite to the side where the outer surface of the lid member 6 is located.

In the covering portion 42 of the insulator 26, the extending end face 43 forms the protruding end of the protruding portion from the outer surface of the lid member 6, and the extending end face 43 serves as a protruding end surface of the protruding portion from the outer surface of the lid member 6. In the insulator 26, a protruding height H2 is defined as a dimension from a base position to a protruding end in the protruding portion of the covering portion 42. The protruding height H2 of the insulator 26 corresponds to the distance from the outer surface of the lid member 6 to the extending end face 43, which is the protruding end face, along the axial direction of the terminal 16 (the height direction of the battery 1). The protruding height H2 of the covering portion 42 of the insulator 26 is greater than the distance D2 between the head end faces 33 and 35 of the terminal head 32 of the terminal 16. That is, the distance between the extending end face 43 of the covering portion 42 of the insulator 26 and the outer surface of the lid member 6, which corresponds to the protruding height H2, is greater than the distance D2 between the head end faces 33 and 35.

In the present embodiment, in the mounting portion of the terminal 16 to the exterior part 3, the protruding height H2 of the covering portion 42 of the insulator 26 from the outer surface of the lid member 6 (the exterior part 3) is the protruding height H1 of the terminal head 32 of the terminal 16 from the outer surface of the lid member 6 or more over the entire circumference in the circumferential direction of the terminal 16 (the covering portion 42). In the example in FIGS. 1 to 5 and the like, the protruding height H2 of the covering portion 42 is higher than the protruding height H1 of the terminal head 32 over the entire circumference in the circumferential direction. Therefore, in the example of FIGS. 1 to 5 and the like, the covering portion 42 further protrudes from the head end face 33, which is the protruding end face of the terminal head 32, to the side opposite to the side where the outer surface of the lid member 6 is located, over the entire circumference in the circumferential direction.

In the configuration in which the protruding height H2 of the covering portion 42 is higher than the protruding height H1 of the terminal head 32 over the entire circumference in the circumferential direction, as in the example in FIGS. 1 to 5 and the like, a recess 46 is formed with the terminal head 32 of the terminal 16 and the covering portion 42 of the insulator 26. The recess 46 is recessed to the side opposite to the side to which the terminal head 32 and the covering portion 42 protrude from the outer surface of the lid member 6. In the recess 46, a bottom surface serving as a bottom portion and an outer peripheral surface enveloping the recess 46 from the outer peripheral side are defined. The bottom surface of the recess 46 is formed by the terminal head 32 of the terminal 16, and is formed by the head end face (first head end face) 33 which is a protruding end face of the terminal head 32. The outer peripheral surface of the recess 46 is formed by the inner peripheral surface of the covering portion 42 and by a portion of the covering portion 42 that further protrudes from the head end face 33 of the terminal head 32.

In the covering portion 42 of the insulator 26, a thickness T1 is defined as a dimension from the inner peripheral surface to the outer peripheral surface in the radial direction. In one example of the present embodiment, the thickness T1 of the covering portion 42 of the insulator 26 is the separation distance D1 between the outer surface of the lid member 6 and the terminal head 32 or more. The thickness T1 of the covering portion 42 is the separation distance D1 or more over the entire circumference in the circumferential direction. Therefore, the covering portion 42 is formed to the thickness T1 having a thickness of the gap between the terminal head 32 and the outer surface of the lid member 6 or more.

However, in the present embodiment, in the projected view from the height direction of the battery 1, the outer peripheral surface of the covering portion 42 is positioned in a range surrounded by the peripheral edge 14 of the lid member 6 over the entire circumference in the circumferential direction. The entire insulator 26 including the covering portion 42 is located between the pair of short edges 17 in the lateral direction of the battery 1 and between the pair of long edges 18 in the depth direction of the battery 1. Therefore, the covering portion 42 does not protrude outward beyond the peripheral edge 14 of the lid member 6, and does not protrude outward in the depth direction of the battery 1 beyond each of the long edges 18.

As shown in FIG. 3 and the like, the covering portion 42 of the insulator 26 that covers the terminal head 32 of the terminal 16 from the outer peripheral side includes two pairs of adjacent portions 51 and 52. The pair of adjacent portions (first adjacent portions) 51 are adjacent to the terminal head 32 from opposite sides to each other in the lateral direction of the battery 1. Therefore, the terminal head 32 is sandwiched between the pair of adjacent portions 51 in the lateral direction of the battery 1. The pair of adjacent portions (second adjacent portions) 52 are adjacent to the terminal head 32 from opposite sides to each other in the depth direction of the battery 1. Therefore, the terminal head 32 is sandwiched between the pair of adjacent portions 52 in the depth direction of the battery 1.

In the present embodiment, the dimension of the lid member 6 in the depth direction of the battery 1 is smaller than the dimension of the lid member 6 in the lateral direction of the battery 1, and the distance D4 is smaller than the distance D3. Thus, in the present embodiment, it is preferable that a thickness T1b of each of the adjacent portions (second adjacent portions) 52 is smaller than a thickness T1a of each of the adjacent portions (first adjacent portions) 51.

As shown in FIG. 5 and the like, in the present embodiment, a pair of recessed portions 55 are formed in the outer surface of the lid member 6, and one recessed portion 55 is formed in each of the mounting portions of the terminals 16 to the lid member 6. In the projected view from the height direction of the battery 1, the recessed portions 55 are located in a range surrounded by the peripheral edge 14 of the lid member 6. Hereinafter, one of the pair of recessed portions 55 and a configuration related to the recessed portion 55 will be described. The other of the pair of recessed portions 55 and the configuration related to the recessed portion 55 are the same as the configuration described below.

In the mounting portion of the terminal 16, the recessed portion 55 is recessed toward the side opposite to the side where the terminal head 32 and the covering portion 42 protrude from the outer surface of the lid member 6. The recessed portion 55 has a recess bottom surface 56 as a bottom portion and a recess outer peripheral surface 57 enveloping the recessed portion 55 from the outer peripheral side. In the mounting portion of the terminal 16, the through hole 25 is formed in the recess bottom surface 56 of the recessed portion 55. In the terminal 16, the entire terminal head 32 is located on the inner peripheral side of the recessed portion 55 with respect to the recess outer peripheral surface 57. Therefore, the outer peripheral surface of the terminal head 32 is located on the inner peripheral side of the recessed portion 55 (terminal 16) with respect to the recess outer peripheral surface 57. The terminal head 13 of the terminal 16 sandwiches the bottom portion 41 of the insulator 26 between the head end face 35 and the recess bottom surface 56.

The covering portion 42 of the insulator 26 is extended from a position on the inner peripheral side with respect to the recess outer peripheral surface 57 toward the outer peripheral side of the recessed portion 55. The covering portion 42 extends beyond the recess outer peripheral surface 57 to a position on the outer peripheral side with respect to the recess outer peripheral surface 57. Thus, the covering portion 42 includes an inner peripheral portion 61 on the inner peripheral side with respect to the recess outer peripheral surface 57 and an outer peripheral portion 62 on the outer peripheral side with respect to the recess outer peripheral surface 57. In the covering portion 42, each of the inner peripheral portion 61 and the outer peripheral portion 62 is formed over the entire circumference in the circumferential direction. In the covering portion 42, the inner peripheral portion 61 abuts on the recess bottom surface 56, and the outer peripheral portion 62 abuts on the outer surface of the lid member 6 (the outer surface of the exterior part 3) in a region on the outer peripheral side with respect to the recess outer peripheral surface 57.

In the covering portion 42, a dimension T2 occupied by the inner peripheral portion 61 in the thickness T1 of the covering portion 42 is defined as the dimension of the inner peripheral portion 61 in the radial direction of the terminal 16. In the covering portion 42, a dimension T3 occupied by the outer peripheral portion 62 in the thickness T1 of the covering portion 42 is defined as the dimension of the outer peripheral portion 62 in the radial direction of the terminal 16. In the covering portion 42, the dimension T3 is the dimension T2 or more over the entire circumference in the circumferential direction. The dimension T3 corresponds to the protruding length of the portion of the covering portion 42 protruding from the recessed portion 55 to the outer peripheral side.

Further, a distance D5 from the recess outer peripheral surface 57 to the respective long edges 18 of the lid member 6 along the depth direction of the battery 1 is defined. In the present embodiment, as described above, the entire insulator 26 including the covering portion 42 is located between the pair of long edges 18 in the depth direction of the battery 1. Therefore, the dimension T3 occupied by the outer peripheral portion 62 in the thickness T1 of the covering portion 42 is smaller than the distance D5.

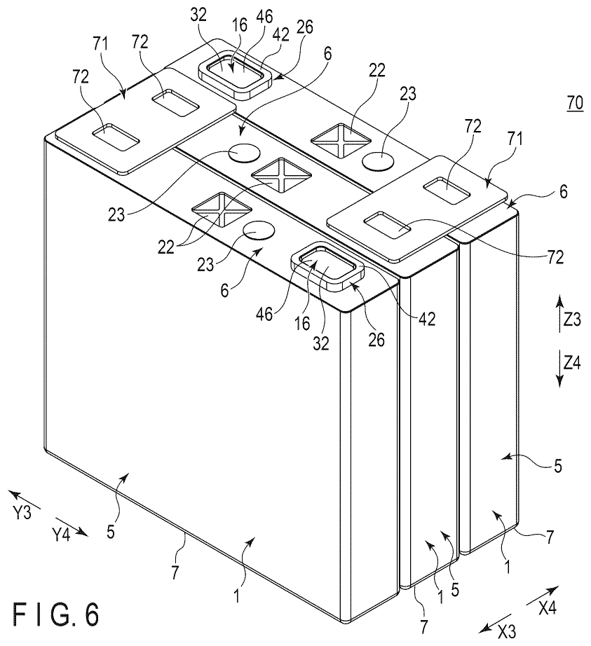

In the present embodiment, a battery module is assembled using a plurality of batteries 1 as described above. FIG. 6 shows an example of a battery module 70 of the present embodiment. As shown in FIG. 6, the battery module 70 includes a plurality of the batteries 1 described above, and the plurality of batteries 1 are aligned. In the battery module 70, a depth direction (a direction indicated by an arrow X3 and an arrow X4), a lateral direction (a direction indicated by an arrow Y3 and an arrow Y4) intersecting (orthogonal or substantially orthogonal) with the depth direction, and a height direction (a direction indicated by an arrow Z3 and an arrow Z4) intersecting (orthogonal or substantially orthogonal) with both the depth direction and the lateral direction are defined. In the battery module 70, the plurality of batteries 1 are aligned along the depth direction, and the depth direction coincides or substantially coincides with the alignment direction of the batteries 1.

Each of the plurality of batteries 1 is arranged in a state where the depth direction coincides or substantially coincides with the depth direction of the battery module 70, and the lateral direction coincides or substantially coincides with the lateral direction of the battery module 70. The height direction of each of the plurality of batteries 1 coincides or substantially coincides with the height direction of the battery module 70. In the battery module 70, the outer surfaces of the lid members 6 of the plurality of batteries 1 face the same side as each other in the height direction. In the battery module 70, the terminal heads 32 of the terminals 16 of the plurality of batteries 1 protrude from the outer surface of the lid member 6 toward the same side as each other in the height direction.

In the battery module 70, the plurality of batteries 1 are electrically connected to each other with the bus bars 71 formed of a conductive material. Therefore, one of the plurality of batteries 1 is electrically connected to an additional battery, which is another battery 1, via the bus bar 71. In the example of FIG. 6, the batteries 1 adjacent to each other in the alignment direction are electrically connected in series by one bus bar 71. The plurality of batteries 1 provided in the battery module 70 are electrically connected in series by using the plurality of bus bars 71. In the battery module 70, the plurality of batteries 1 may be electrically connected in parallel by using one or more bus bars 71. Further, both a structure in which the plurality of batteries 1 are electrically connected in series and a structure in which the plurality of batteries 1 are electrically connected in parallel may be formed by one or more bus bars.

The bus bar 71 is formed in a plate shape, and a plate thickness direction is defined in the bus bar 71. In the battery module 70, the bus bar 71 electrically connects the two batteries 1 in a state where the plate thickness direction of the bus bar 71 coincides or substantially coincides with the height direction of the battery module 70. Further, the bus bar 71 is formed with an insertion piece part 72. In the bus bar 71, the insertion piece part 72 protrudes toward one side in the plate thickness direction. In each of the plurality of batteries 1 of the battery module 70, the protruding height H2 of the covering portion 42 of the insulator 26 is higher than the protruding height H1 of the terminal head 32 of the terminals 16 over the entire circumference in the circumferential direction in the mounting portion of each of the pair of terminals 16. Therefore, in each of the plurality of batteries 1, the above-described recess 46 is formed in the mounting portion of each of the pair of terminals 16.

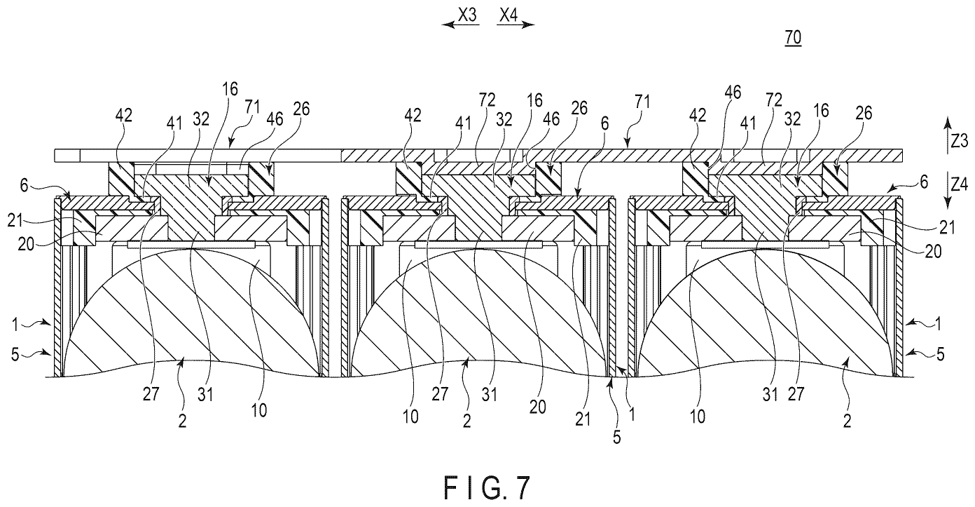

FIG. 7 illustrates a configuration in which bus bars 71 are connected to the terminals 16 of the batteries 1 in the battery module 70. In FIG. 7, a cross section orthogonal or substantially orthogonal to the lateral direction of the battery module 70 is shown. In addition, FIG. 7 shows a cross section passing through one of the pair of terminals 16 in each of the plurality of batteries 1 and one of the bus bars 71. Hereinafter, a configuration in which the bus bar 71 is connected to any one of the pair of terminals 16 in one of the plurality of batteries 1 will be described. In the battery module 70, the other terminals 16 are also connected to the bus bars 71 in the same manner as in the configuration described below.

In the present embodiment, the insertion piece part 72 of the bus bar 71 is inserted into the recess 46 formed by the terminal head 32 and the covering portion 42. The insertion piece part 72 is joined to the terminal head 32 in a state of being inserted into the recess 46. That is, in the recess 46, the insertion piece part 72 is joined to the head end face (first head end face) 33 of the terminal head 32, which serves as the bottom surface of the recess 46. The insertion piece part 72 is joined to the terminal head 32 in the recess 46, and thus the bus bar 71 is connected to the terminal 16.

In the recess 46, the insertion piece part 72 of the bus bar 71 abuts on the outer peripheral surface of the recess 46, that is, the inner peripheral surface of the covering portion 42. In the present embodiment, in the projected view from the height direction of the battery 1, the recess 46 has a quadrangular shape or a substantially quadrangular shape. In addition, in the projected view from the plate thickness direction of the bus bar 71, the insertion piece part 72 has a quadrangular shape or a substantially quadrangular shape which is similar to the quadrangular shape or the substantially quadrangular shape of the recess 46, and has a slightly smaller area than the quadrangular shape or the substantially quadrangular shape of the recess 46. In the recess 46, the insertion piece part 72 abuts on the inner peripheral surface of the covering portion 42 over the entire circumference or substantially the entire circumference of the covering portion 42 (terminal 16) in the circumferential direction.

In the case of assembling a battery module 70 or the like in which a plurality of batteries 1 are electrically connected, a bus bar 71 is connected to the terminal 16, and the plurality of batteries are electrically connected via the bus bar 71. In addition, to confirm the dimensions of the battery module 70 to be assembled, measurement and the like of the dimensions of the batteries 1 forming the battery module 70 are performed. In the battery 1 of the present embodiment, the terminal head 32 is covered by the covering portion 42 of the insulator 26 from the outer peripheral side in the respective mounting portions of the terminals 16. The covering portion 42 abuts on the outer surface of the exterior part 3 (the outer surface of the lid member 6), and the protruding height H2 of the covering portion 42 from the outer surface of the exterior part 3 is the protruding height H1 of the terminal head 32 from the outer surface of the exterior part 3 or more over the entire circumference.

With such a configuration, in the work of assembling the battery module 70 or the like, the covering portion 42 appropriately prevents the terminal head 32 from unintentionally coming into contact with a conductor such as a metal component or a jig. Thus, in the work of assembling the battery module using the batteries 1 in which the terminal heads 32 of the terminals 16 are arranged outside the exterior parts 3, the occurrence of a short circuit caused by contact of the terminal heads 32 with the conductors is appropriately prevented.

In addition, since the protruding height H2 of the covering portion 42 is the protruding height H1 of the terminal head 32 or more in the respective mounting portions of the terminals 16, the clearance and the creepage distance of the outer surface of the exterior parts 3 (outer surface of the lid members 6) of the batteries 1 with respect to the bus bars 71 are increased in the battery module 70. This further appropriately prevents the occurrence of a short circuit between the bus bar 71 and the exterior part 3.

In the present embodiment, the protruding height H2 of the covering portion 42 is set to be higher than the protruding height H1 of the terminal head 32 over the entire circumference, and thus the recess 46 is formed in which the head end face (first head end face) 33 of the terminal head 32 is recessed with respect to the extending end face 43 of the covering portion 42. The formation of the recess 46 further appropriately prevents the terminal head 32 from unintentionally contacting the conductor. Further, with the configuration in which the recess 46 is formed in each of the mounting portions of the terminals 16, the creepage distance between the terminal head 32 and the region on the outer peripheral side with respect to the covering portion 42 of the outer surface of the exterior part 3 increases. Thus, in the battery 1, the occurrence of a short circuit between each of the terminals 16 and the exterior part 3 is further appropriately prevented.

As described above, in the present embodiment, the insulation between the conductors is improved in the battery 1 and the battery module 70 in which the plurality of batteries 1 are assembled. Therefore, at the time of using the battery 1 and the like, the occurrence of a short circuit is appropriately prevented, and safety is improved. In addition, the occurrence of a short circuit is appropriately prevented during the assembly work of the battery module 70, during the use of the battery module 70, and the like, and thus safety is improved.

In the present embodiment, the distance between the extending end face 43 of the covering portion 42 of the insulator 26 and the outer surface of the exterior part 3 is greater than the distance D2 between the head end faces 33 and 35 of the terminal head 32. Therefore, the configuration in which the protruding height H2 of the covering portion 42 of the insulator 26 is the protruding height H1 of the terminal head 32 of the terminal 16 or more in the mounting portion of each of the terminals 16 can be easily realized.

In the example of the battery 1 shown in FIGS. 1 to 5, the thickness T1 of the covering portion 42 of the insulator 26 is the separation distance D1 between the outer surface of the exterior part 3 and the terminal head 32 or more. In the example of FIGS. 1 to 5, the recessed portion 55 is formed on the outer surface of the exterior part 3 at each of the mounting portions of the terminals 16, and the terminal head 32 is located on the inner peripheral side with respect to the recess outer peripheral surface 57 of the recessed portion 55. The covering portion 42 of the insulator 26 extends from a position on the inner peripheral side with respect to the recess peripheral surface 57 to the outer peripheral side of the recessed portion 55 beyond the recess outer peripheral surface 57. With such a configuration, the thickness T1 of the covering portion 42 increases. In addition, in the case where the recessed portion 55 is formed, the thickness T1 of the covering portion 42 is further increased by setting the dimension T3 occupied by the outer peripheral portion 62 on the outer peripheral side with respect to the recess outer peripheral surface 57 to be the dimension T2 occupied by the inner peripheral portion 61 on the inner peripheral side with respect to the recess outer peripheral surface 57 or more.

In each of the batteries 1 forming the battery module 70, the thickness T1 of the covering portion 42 increases in the mounting portion of each of the terminals 16, and thus the movement of the bus bar 71 connected to the terminals 16 is appropriately suppressed by the covering portion 42. For example, even if a force acts on the covering portion 42 from the bus bar 71 due to vibration or the like of the battery module 70, a reaction force against the force from the bus bar 71 appropriately acts on the bus bar 71 from the covering portion 42, and the movement of the bus bar 71 is appropriately prevented by the reaction force from the covering portion 42. That is, the fixing force of the bus bar 71 connected to the terminal 16 is improved. This effectively prevents the bus bar 71 from being separated from the terminal 16 due to vibration or the like of the battery module 70, and improves the structural reliability of the battery module 70.

In the battery module 70 of the example shown in FIGS. 6 and 7 and the like, the insertion piece part 72 of the bus bar 71 is inserted into the recess 46 formed by the terminal head 32 and the covering portion 42 in the connection portion of the bus bar 71 to each of the terminals 16. The insertion piece part 72 of the bus bar 71 is joined to the terminal head 32 in the recess 46. With such a configuration, the bus bar 71 can be easily positioned during assembling of the battery module 70.

In the battery module 70, the insertion piece part 72 of the bus bar 71 abuts on the outer peripheral surface of the recess 46, that is, the covering portion 42, in the recess 46. This makes it easier to position the bus bar 71 during assembling of the battery module 70. Since the bus bar 71 is easily positioned in the assembly of the battery module 70, the workability of the work of assembling the battery module 70 is improved. This improves the productivity of the battery module 70.

In the battery 1 of the example shown in FIGS. 1 to 5, in the mounting portion of each terminal 16, the covering portion 42 includes a pair of adjacent portions 51 adjacent to the terminal head 32 from opposite sides to each other in the lateral direction, and a pair of adjacent portions 52 adjacent to the terminal head 32 from opposite sides to each other in the depth direction. In one example, the thickness T1b of each of the adjacent portions 52 is smaller than the thickness T1a of each of the adjacent portions 51. In the manufacturing of the battery 1, the lid member 6 is welded to the exterior container 5, as described above. By making the thickness T1b thinner by making the thickness T1b smaller than the thickness T1a and the like, the influence of heat, generated by welding the lid member 6 to the exterior container 5, on the covering portion 42 is reduced.

### (Modification)

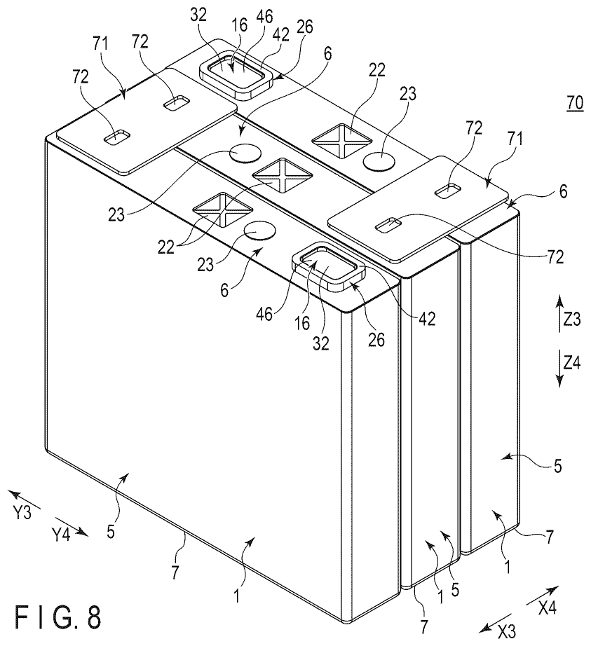

In the connection portion of the bus bar 71 to each of the terminals 16, the insertion piece part 72 of the bus bar 71 may abut on the inner peripheral surface of the covering portion 42 (the outer peripheral surface of the recess 46) only in a partial range in the circumferential direction of the covering portion 42 (the terminal 16). In a battery module 70 of a first modification shown in FIG. 8, in the projected view from the plate thickness direction of the bus bar 71, the insertion piece part 72 has an elliptical shape or a substantially elliptical shape having a smaller area than the quadrangular shape or the substantially quadrangular shape of the recess 46. In the battery module 70, the bus bar 71 electrically connects the two batteries 1 in a state where the major axis direction of the elliptical shape or the substantially elliptical shape of the insertion piece part 72 coincides or substantially coincides with the depth direction of the battery module 70 (the depth direction of each of the batteries 1).

In this modification, the insertion piece part 72 of the bus bar 71 is inserted into the recess 46 in the connection portion of the bus bar 71 to each of the terminals 16, and the insertion piece part 72 is joined to the head end face 33 of the terminal head 32 in the recess 46. In this modification, the insertion piece part 72 abuts on the inner peripheral surface of the covering portion 42 (the outer peripheral surface of the recess 46) only at two locations in the recess 46 that are spaced apart from each other in the circumferential direction of the terminal 16 (the covering portion 42). In the inner peripheral surface of the covering portion 42, a portion on which the insertion piece part 72 abuts is formed in each of the pair of adjacent portions (second adjacent portions) 52, and the insertion piece part 72 does not abut on the pair of adjacent portions (first adjacent portions) 51. In the recess 46, two locations where the insertion piece part 72 abuts on the covering portion 42 are located at an interval of, for example, 180° or substantially 180° in the circumferential direction of the terminal 16.

In a modification, the bus bar 71 electrically connects two batteries 1 in a state where the major axis direction of the elliptical shape or the substantially elliptical shape of the insertion piece part 72 coincides or substantially coincides with the lateral direction of the battery module 70 (the lateral direction of each of the batteries 1). Also, in this case, the insertion piece part 72 abuts on the inner peripheral surface of the covering portion 42 (the outer peripheral surface of the recess 46) only in two locations separated from each other in the circumferential direction of the terminal 16 (the covering portion 42) in the recess 46. However, in this modification, on the inner peripheral surface of the covering portion 42, a portion on which the insertion piece part 72 abuts is formed at each of the pair of adjacent portions (first adjacent portions) 51, and the insertion piece part 72 does not abut on the pair of adjacent portions (second adjacent portions) 52.

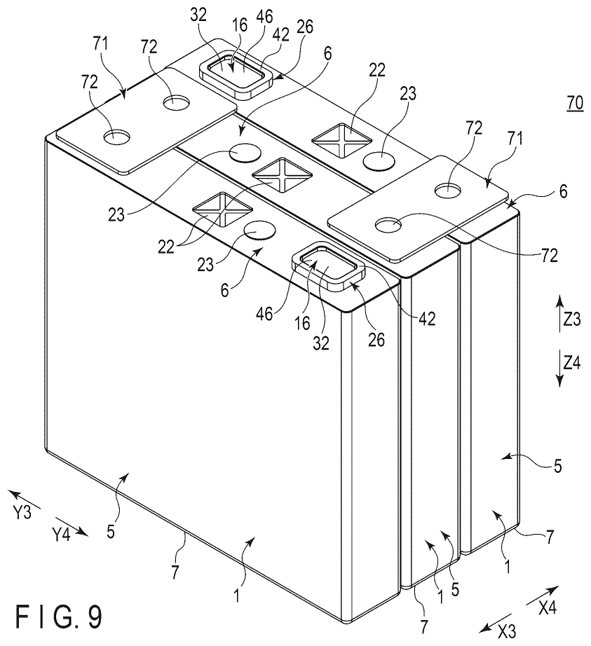

In a battery module 70 of a second modification shown in FIG. 9, in the projected view from the plate thickness direction of the bus bar 71, the insertion piece part 72 has a circular shape or a substantially circular shape having a smaller area than the quadrangular shape or the substantially quadrangular shape of the recess 46. In this modification, the insertion piece part 72 abuts on the inner peripheral surface of the covering portion 42 (the outer peripheral surface of the recess 46) only at four locations spaced apart from each other in the circumferential direction of the terminal 16 (the covering portion 42) in the recess 46. In the inner peripheral surface of the covering portion 42, a portion on which the insertion piece part 72 abuts is formed at one location each on the pair of adjacent portions (first adjacent portions) 51 and the pair of adjacent portions (second adjacent portions) 52. In the recess 46, four locations on which the insertion piece parts 72 abut the covering portion 42 are located at intervals of, for example, 90° or substantially 90° in the circumferential direction of the terminal 16.

In the modification example of FIG. 8 and the modification example of FIG. 9 and the like, the insertion piece part 72 of the bus bar 71 is joined to the terminal head 32 in the recess 46, as in the first embodiment and the like. In addition, the insertion piece part 72 of the bus bar 71 abuts on the outer peripheral surface of the recess 46, that is, the covering portion 42, in the recess 46. Therefore, in the above-described modification and the like, the bus bar 71 can be easily positioned during assembling of the battery module 70. Therefore, in the above-described modifications and the like, the workability of the work of assembling the battery module 70 is improved, and the productivity of the battery module 70 is improved.

In the above-described embodiment and the like, the exterior part 3 includes the exterior container 5 and the lid member 6, but the configuration of the exterior part is not limited to the above. As long as the pair of terminals 16 are attached to the exterior part, the same configuration as that of any of the above-described embodiments and the like can be applied to the mounting portions of the terminals 16 to the exterior part.

That is, in the above-described embodiment, modifications, and the like, the terminal head 32 of the terminal 16 is arranged outside the exterior part in the mounting portion of each terminal 16 to the exterior part. The bottom portion 41 of the insulator 26 is sandwiched between the terminal head 32 and the outer surface of the exterior part, and the covering portion 42 of the insulator 26 covers the terminal head 32 from the outer peripheral side of the terminal 16 on the outer surface of the exterior part. The covering portion 42 abuts on the outer surface of the exterior part, and the protruding height H2 of the covering portion 42 from the outer surface of the exterior part is the protruding height H1 of the terminal head 32 from the outer surface of the exterior part or more over the entire circumference. With such a configuration, in the work of assembling the battery module and the like, the covering portion 42 appropriately prevents the terminal head 32 from unintentionally coming into contact with the conductor. In the battery 1 and the battery module in which the plurality of batteries 1 are assembled, the insulation between the conductors is improved, and the safety is improved.

In the battery 1, at least one of the mounting portion of the positive electrode terminals 16A to the exterior part and the mounting portion of the negative electrode terminals 16B to the exterior part may have the same configuration as that of any of the above-described embodiments and the like. In the case where the mounting portion of the positive electrode terminals 16A to the exterior part has the same configuration as that of the above-described embodiments and the like, the positive electrode terminals 16A have the same configuration as that of any of the above-described terminals 16, and the positive electrode side insulators 26A have the same configuration as that of any of the above-described insulators 26. In the case where the mounting locations of the negative electrode terminals 16B to the exterior part are the same positions as those in the above-described embodiments and the like, the negative electrode terminals 16B have the same configuration as any of the terminals 16 described above, and the negative electrode side insulators 26B have the same configuration as any of the insulators 26 described above.

According to at least one of these embodiments or examples, the bottom portion of the insulator is sandwiched between the terminal head and the outer surface of the exterior part, and the covering portion of the insulator covers the terminal head from the outer peripheral side of the terminal on the outer surface of the exterior part. The covering portion abuts on the outer surface of the exterior part, and the protruding height of the covering portion from the outer surface of the exterior part is the protruding height of the terminal head from the outer surface of the exterior part or more over the entire circumference. Thus, it is possible to provide a battery in which unintended contact of the terminal head arranged outside the exterior part with the conductor is appropriately prevented in the work of assembling the battery module and the like, and a battery module including such batteries.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A battery comprising:
an exterior part having an internal cavity;
an electrode group including a positive electrode and a negative electrode, and housed in the internal cavity;
a terminal inserted into the internal cavity through the exterior part and electrically connected to the electrode group, the terminal including a terminal head arranged outside the exterior part; and
an insulator having an electrical insulation property, the insulator including a bottom portion sandwiched between the terminal head and an outer surface of the exterior part, and a covering portion covering the terminal head from an outer peripheral side of the terminal on the outer surface of the exterior part, the covering portion abutting on the outer surface of the exterior part, a protruding height of the covering portion from the outer surface of the exterior part being a protruding height of the terminal head from the outer surface of the exterior part or more over an entire circumference.

2. The battery according to claim 1, wherein
a thickness of the covering portion is a separation distance between the outer surface of the exterior part and the terminal head or more.

3. The battery according to claim 1, wherein
the terminal head of the terminal includes:
a first head end face that forms an end of the terminal head on a side far from the outer surface of the exterior part, and that faces a side opposite to a side on which the outer surface of the exterior part is located; and
a second head end face that forms an end of the terminal head on a side close to the outer surface of the exterior part, and that opposes the outer surface of the exterior part with the bottom portion of the insulator sandwiched between the second head end face and the outer surface of the exterior part,
the covering portion of the insulator includes an extending end face that forms an end of the covering portion on the side far from the outer surface of the exterior part, and that faces the side opposite to the side on which the outer surface of the exterior part is located, and
a distance between the outer surface of the exterior part and the extending end face of the covering part is greater than a distance between the first head end face and the second head end face of the terminal head.

4. The battery according to claim 1,
wherein the exterior part includes:
an exterior container including a bottom wall and a peripheral wall, the internal cavity being open to a side opposite to a side where the bottom wall is located in a height direction; and
a lid member that is attached to the peripheral wall of the exterior container in a state of closing an opening of the internal cavity, and through which the terminal penetrates,
the bottom portion of the insulator is sandwiched between the terminal head and an outer surface of the lid member, and
the covering portion of the insulator covers the terminal head from the outer peripheral side of the terminal on the outer surface of the lid member.

5. The battery according to claim 4, wherein
a dimension of the lid member in a depth direction intersecting the height direction is smaller than a dimension of the lid member in a lateral direction intersecting both the height direction and the depth direction,
the covering portion of the insulator includes a pair of first adjacent portions adjacent to the terminal head of the terminal from opposite sides to each other in the lateral direction, and a pair of second adjacent portions adjacent to the terminal head of the terminal from opposite sides to each other in the depth direction, and
a thickness of each of the second adjacent portions is smaller than a thickness of each of the first adjacent portions.

6. The battery according to claim 4, wherein
the lid member includes a peripheral edge forming an edge of the outer surface of the lid member, and
in a projected view from the height direction, an outer peripheral surface of the covering portion of the insulator is located in a range surrounded by the peripheral edge of the lid member over the entire circumference.

7. The battery according to claim 1, wherein
the exterior part includes a recessed portion that is recessed in the outer surface of the exterior part and that defines a recess bottom surface and a recess outer peripheral surface,
the terminal head of the terminal is located on an inner peripheral side of the recessed portion with respect to the recess outer peripheral surface, and sandwiches the bottom portion of the insulator between the terminal head and the recess bottom surface, and
the covering portion of the insulator is extended from a location on the inner peripheral side of the recessed portion with respect to the recess outer peripheral surface to an outer peripheral side of the recessed portion beyond the recess outer peripheral surface.

8. The battery according to claim 7, wherein
in a thickness of the covering portion of the insulator, a dimension occupied by an outer peripheral portion on the outer peripheral side with respect to the recess outer peripheral surface is a dimension occupied by an inner peripheral portion on the inner peripheral side with respect to the recess outer peripheral surface or more.

9. The battery according to claim 1, wherein at least one of following is true:
a positive electrode terminal electrically connected to the positive electrode of the electrode group is the terminal including the terminal head, and a positive electrode side insulator corresponding to the positive electrode terminal is the insulator including the bottom portion and the covering portion; and
a negative electrode terminal electrically connected to the negative electrode of the electrode group is the terminal including the terminal head, and a negative electrode side insulator corresponding to the negative electrode terminal is the insulator including the bottom portion and the covering portion.

10. A battery module comprising:
the battery according to claim 1;
a bus bar formed of a conductive material and connected to the terminal of the battery; and
an additional battery electrically connected to the battery via the bus bar.

11. The battery module according to claim 10, wherein
in the battery, a recess is formed with the terminal head of the terminal and the covering portion of the insulator,
in the recess, a bottom surface of the recess is formed with the terminal head,
the bus bar includes an insertion piece part to be inserted into the recess, and
the insertion piece part of the bus bar is joined to the terminal head of the terminal in the recess.

12. The battery module according to claim 11, wherein
in the recess, an outer peripheral surface of the recess is formed with the covering portion, and
the insertion piece part of the bus bar abuts on the outer peripheral surface of the recess in the recess.
